(19) United States
(12) Patent Application Publication
(10) Pub. No.: US 2022/0299181 A1
(43) Pub. Date: Sep. 22, 2022

(54) VEHICLE HEADLIGHT DEVICE

(71) Applicant: HONDA MOTOR CO., LTD., Tokyo (JP)

(72) Inventors: Masayoshi TAKORI, Saitama (JP); Shinya KOGURE, Saitama (JP)

(21) Appl. No.: 17/680,318

(22) Filed: Feb. 25, 2022

(30) Foreign Application Priority Data
Mar. 18, 2021 (JP) 2021-044623

(51) Int. Cl. F21S 41/14; F21S 41/675

(52) U.S. Cl. CPC F21S 41/14; F21S 41/675

(57) ABSTRACT

Provided is a vehicle headlight device including: a first light irradiator that irradiates light from a light source at a first magnification m1 in a form of a first radiation pattern in which a bright region and a dark region are alternately repeated; and a second light irradiator that irradiates light from a light source at a second magnification in a form of a second radiation pattern in which an entire region is a bright region. In the vehicle headlight device, directivity of the light radiated from the first light irradiator overlaps with directivity of the light radiated from the second light irradiator, and the first magnification m1 is smaller than the second magnification. Thus, it is possible to prevent or reduce failure to notice a pedestrian by a driver even under adverse conditions such as nighttime and rainy weather.

This application is based on and claims the benefit of priority from Japanese Patent Application No. 2021-044623, filed on 18 Mar. 2021, the content of which is incorporated herein by reference.

### BACKGROUND OF THE INVENTION

### Field of the Invention

The present invention relates to a vehicle headlight device.

### Related Art

As a vehicle headlight device, a device has been proposed which inhibits a pedestrian from being dazzled and suitably allows a driver to visually perceive the pedestrian (for example, see Patent Document 1). The vehicle headlight device disclosed in Patent Document 1 detects the distance to the pedestrian by way of a pedestrian detection sensor and reduces an amount of illumination to the upper body of the pedestrian depending on the detected distance.
Patent Document 1: Japanese Unexamined Patent Application, Publication No. 2013-184614

### SUMMARY OF THE INVENTION

However, accidents tend to occur more frequently due to failure to notice a pedestrian in front of a vehicle on a straight road section. It is necessary to prevent such failure to notice the pedestrian, but the current vehicle headlight devices do not provide sufficient measures, especially under adverse conditions such as nighttime and rainy weather.

The present invention has been made in view of the above-described circumstances, and is to provide a vehicle headlight device capable of preventing or reducing failure to notice a pedestrian by a driver even under adverse conditions such as nighttime and rainy weather.

(1) A vehicle headlight device (for example, a vehicle headlight device 1 to be described below) including: a first light irradiator (for example, a first light irradiator 4 to be described below) that irradiates light from a light source (for example, a planar-emission-type light source 11 to be described below) at a first magnification (for example, a first magnification m1 to be described below) in a form of a first radiation pattern (for example, a first radiation pattern P1 to be described below) in which a bright region (for example, a bright region 15 to be described below) and a dark region (for example, a dark region 16 to be described below) are alternately repeated; and a second light irradiator (for example, a low beam irradiator 5 and/or a high beam irradiator 6 to be described below) that irradiates light from a light source (for example, a planar-emission-type light source 11a to be described below) at a second magnification (for example, a second magnification m2 to be described below) in a form of a second radiation pattern (for example, a second radiation pattern P2 to be described below) in which an entire region is a bright region, wherein directivity of the light radiated from the first light irradiator overlaps with directivity of the light radiated from the second light irradiator, and the first magnification is smaller than the second magnification.

(2) In the vehicle headlight device of (1), the first radiation pattern is a stripe pattern (for example, a stripe pattern P1 to be described below) in which the bright region and the dark region are arranged in parallel.

(3) In the vehicle headlight device of (1), the first radiation pattern is a grid-like pattern in which the bright region having a grid shape is formed in the dark region.

(4) In the vehicle headlight device of (1), the first radiation pattern is a checkered pattern (for example, a checkered pattern P1b to be described below) in which the bright region having a rectangular shape and the dark region having a rectangular shape are arranged in a checkered pattern.

(5) In the vehicle headlight device of (1), the first radiation pattern is a rhombic checkered pattern (for example, a rhombic checkered pattern P1c to be described below) in which the bright region having a rhombic shape and the dark region having a rhombic shape are arranged in a checkered pattern.

(6) In the vehicle headlight device of (1), the first light irradiation unit includes a DMD having a micromirror group corresponding to the first radiation pattern.

(7) In the vehicle headlight device of (1), the first light irradiation unit includes a predetermined planar-emission-type light source and a light shielding mask having a pattern corresponding to the first radiation pattern.

(8) In the vehicle headlight device of (1), the second light irradiation unit is a low beam irradiator and/or a high beam irradiator of an own vehicle.

In the vehicle headlight device of (1), the pedestrian appears to flicker from the driver according to the first radiation pattern and the driver instantaneously recognizes the presence of the distant pedestrian, using the light that reaches a long distant at a low magnification from the first light irradiator in a form of the first radiation pattern in which the bright region and the dark region are alternately repeated. Further, using light spreading over a wide region at a high magnification from the second light irradiator in a form of the second radiation pattern in which the entire region is a bright region, the short-distance field of view is illuminated with high illuminance as seen from the driver. Thus, it is possible to prevent or reduce the failure to notice the pedestrian by the driver even under adverse conditions such as nighttime and rainy weather.

In the vehicle headlight device of (2), when the pedestrian is irradiated with the light of the first radiation pattern, which is a stripe pattern in which the bright region and the dark region are arranged in parallel, the driver can instantaneously recognize the presence of the pedestrian by appearing to flicker according to the first radiation pattern.

In the vehicle headlight device of (3), when the pedestrian is irradiated with the light of the first radiation pattern, which is the grid-like pattern in which the grid-like bright region is formed in the dark region, the driver can instantaneously recognize the presence of the pedestrian by appearing to flicker according to the first radiation pattern.

In the vehicle headlight device of (4), when the pedestrian is irradiated with the light of the first radiation pattern, which is the checkered pattern in which the rectangular bright region and the rectangular dark region are arranged in a checkered pattern, the driver can instantaneously recognize the presence of the pedestrian by appearing to flicker according to the first radiation pattern.

In the vehicle headlight device of (5), when the pedestrian is irradiated with the light of the first radiation pattern, which is the rhombic checkered pattern in which the rhombic bright region and the rhombic dark region are arranged in a checkered pattern, the driver can instantaneously recognize the presence of the pedestrian by appearing to flicker according to the first radiation pattern.

In the vehicle headlight device of (6), when the light is radiated in the form of the first radiation pattern from the DMD including the micromirror group corresponding to the first radiation pattern in the first light irradiator, the pedestrian appears to flicker to the driver, and the presence of the distant pedestrian is instantaneously recognized according to the first radiation pattern. It is possible to prevent or reduce the failure to notice the pedestrian by the driver even under adverse conditions such as nighttime and rainy weather.

In the vehicle headlight device of (7), when the light is radiated in the form of the first radiation pattern from the first light irradiator including the predetermined planar-emission-type light source and the light shielding mask having the pattern corresponding to the first radiation pattern, the pedestrian appears to flicker from the driver, and the presence of the distant pedestrian is instantaneously recognized according to the first radiation pattern. It is possible to prevent or reduce the failure to notice the pedestrian by the driver even under adverse conditions such as nighttime and rainy weather.

According to the vehicle headlight device 1 of (8), the presence of the distant pedestrian is instantaneously recognized by the light radiated from the first light irradiator, while the relatively short-distance field of view is illuminated with high illuminance and the pedestrian is clearly recognized by the light radiated from the second light irradiators.

### BRIEF DESCRIPTION OF THE DRAWINGS

FIG. 1 is a schematic diagram showing a vehicle headlight device according to an embodiment of the present invention;

FIG. 2 is a diagram illustrating an idea relating to light radiation in the vehicle headlight device according to the embodiment of the present invention;

FIG. 3 is a view illustrating a time-series transition of human cognition according to the basic idea of the present invention;

FIG. 4 is a schematic diagram showing a configuration of a first light irradiator in the vehicle headlight device according to the embodiment of the present invention;

FIG. 5 is a diagram schematically showing a light shielding mask applied to the first light irradiator shown in FIG. 4;

FIG. 6 is a diagram showing an example of a first radiation pattern of the vehicle headlight device according to the embodiment of the present invention;

FIG. 7 is a diagram showing another example of a first radiation pattern of the vehicle headlight device according to the embodiment of the present invention;

FIG. 8 is a diagram showing further another example of a first radiation pattern of the vehicle headlight device according to the embodiment of the present invention; and

FIG. 9 is a diagram showing still further another example of a first radiation pattern of the vehicle headlight device according to the embodiment of the present invention.

### DETAILED DESCRIPTION OF THE INVENTION

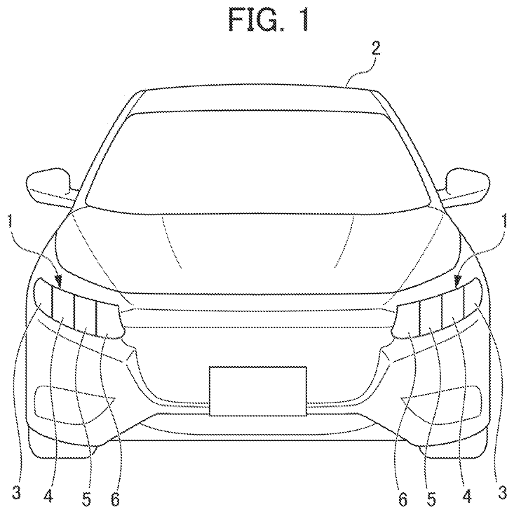

FIG. 1 is a schematic diagram showing vehicle headlight devices 1 according to an embodiment of the present invention. The vehicle headlight devices 1 are provided on a left side and a right side, respectively, in a form of bilateral symmetry when viewed from a central position in a vehicle width direction of a vehicle 2. Each of the vehicle headlight devices 1 includes a turn signal light 3, a first light irradiator 4, a low beam irradiator (second light irradiator) 5, and a high beam irradiator (second light irradiator) 6 which are disposed in order from the outside to the inside in the vehicle width direction.

As will be described below, the first light irradiator 4 irradiates light from a light source 11 at a first magnification m1 in a form of a first radiation pattern P1 in which a bright region 15 and a dark region 16 are alternately repeated. The low beam irradiator 5 irradiates a predetermined low beam light distribution region with light. The high beam irradiator 6 irradiates a predetermined high beam light distribution region with light. Hereinafter, the vehicle 2 including the vehicle headlight devices 1 is appropriately referred to as an own vehicle 2.

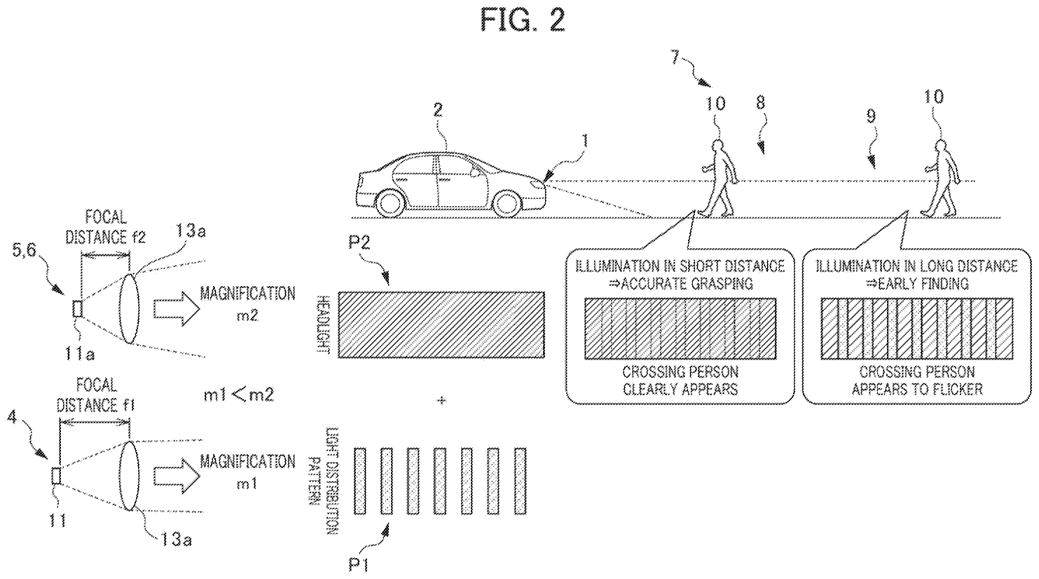

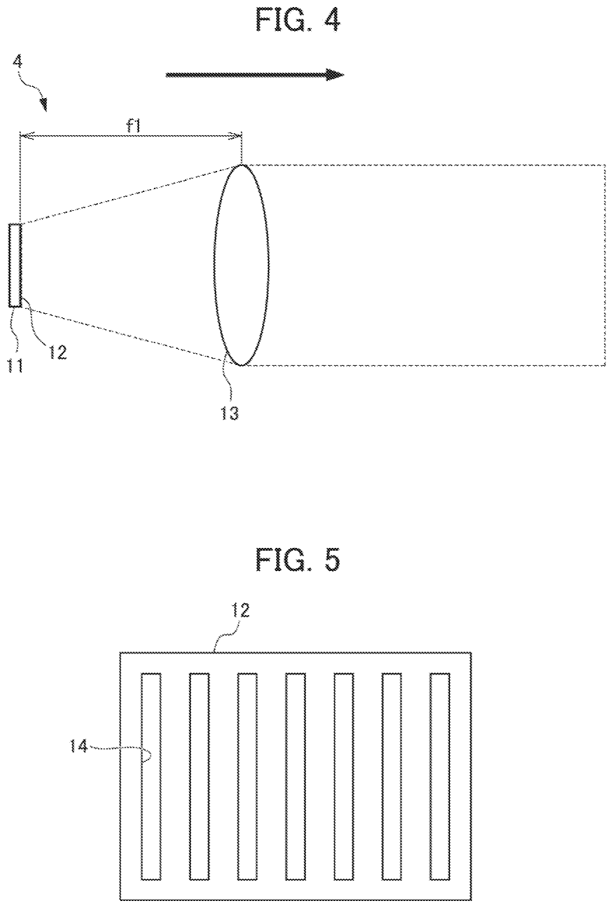

FIG. 2 is a view illustrating an idea relating to light radiation in the vehicle headlight device 1 according to the embodiment of the present invention. It is assumed that the vehicle 2 is provided with the vehicle headlight device 1 including the first light irradiator 4 and the second light irradiators which are the low beam irradiator 5 and the high beam irradiator 6. The first light irradiator 4 has a configuration which will be described below with reference to FIG. 4, and irradiates forward at a first magnification m1 with light emitted from a planar-emission-type light source 11 using a lens 13 having a focal distance f1.

The second light irradiator has substantially the same configuration as the first light irradiator 4, and irradiates forward at a second magnification m2 with light emitted from a planar-emission-type light source 11a using a lens 13a having a focal distance f2. Light is radiated from the first light irradiator 4 in a form of the first radiation pattern P1 (expressed by a “patterned light distribution” in the drawing) in which the bright region 15 and the dark region 16 are alternately repeated, and light is radiated from the low beam irradiator 5 and/or the high beam irradiator 6 which are the second light irradiators, in a form of a second radiation pattern P2 in which the entire region is a bright region. The second radiation pattern is a so-called “uniform light distribution”.

In this case, the first light irradiator 4 irradiates light from the light source 11 at the first magnification m1, which is relatively low, that is, with a narrower beam than normal low beam and high beam. The low beam irradiator 5 and/or the high beam irradiator 6, which are the second light irradiators, radiate light from the light source 11a at the second magnification m2, which is relatively high, that is, with a beam having a predetermined spread of a normal low beam and a predetermined spread of a normal high beam.

At this time, directivity of the light radiated from the first light irradiator 4 overlaps with directivity of the light radiated from the second light irradiator 5 or 6. In other words, an irradiation region of the light radiated from the first light irradiator 4 does not completely overlaps an irradiation region of the light radiated from the second light irradiator 5 or 6, but an optical axis of the light radiated from the first light irradiator 4 substantially overlaps with an optical axis of the light radiated from the second light irradiator 5 or 6.

In a short-distance field of view 8 seen from a driver of the vehicle 2, there is no great difference between illuminance due to the light radiated from the first light irradiator 4 and illuminance due to the light radiated from the second light irradiator 5 or 6, and the short-distance field of view 8 is illuminated with high illuminance by the light radiated from the first light irradiator 4 and the second light irradiator 5 or 6. Therefore, the driver clearly and visually confirms a pedestrian 10 who has entered the short-distance field of view 8 on a road on which the vehicle 2 runs.

On the other hand, in a long-distance field of view 9 as seen from the driver of the vehicle 2, the light radiated from the second light irradiator 5 or 6 is diffused and thus illuminance thereof is reduced, but illuminance of the light radiated from the first light irradiator 4 with the narrower beam is maintained. In particular, the light radiated from the first light irradiator 4 has the first radiation pattern P1 in which the bright region 15 and the dark region 16 are alternately repeated. Therefore, the pedestrian 10, who has entered the long-distance field of view 9 on the road on which the vehicle 2 runs, appears to flicker from the driver according to the first radiation pattern, and the presence of the pedestrian 10 is instantaneously recognized. This makes it possible to prevent or reduce the failure to notice pedestrians by the driver over the region from the short-distance field of view 8 to the long-distance field of view 9 on the road on which the vehicle 2 runs.

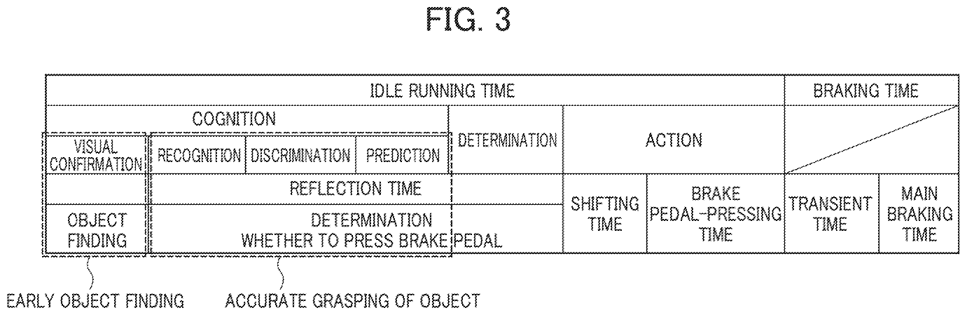

FIG. 3 is a view illustrating a time-series transition of human cognition according to the basic idea of the present invention. In FIG. 3, a time elapses from a left side to a right side. A person, who is a driver of the vehicle, first perceives an object by visual confirmation, that is, by his/her own sense of sight (FIG. 3: visual confirmation, object finding).

Then, mental action is induced, the mental action being caused by perception of the object finding by visual confirmation, that is, recognition→discrimination→prediction. From the recognition to the prediction, even when the visually confirmed object is not in the form of matching based on past experience, visually confirmed object is accurately grasped. The elapsed time from the visual confirmation to determination is a mental reflection time in which no action is taken yet.

The person, who is the driver of the vehicle, takes action based on the determination. The action includes shifting his/her foot from an accelerator pedal to a brake pedal (shifting time) and pressing the brake pedal (brake pedal-pressing time). Until the action is taken from the beginning of the visual confirmation, the braking of the vehicle still does not work, and during this time, the vehicle runs idle (idle running time).

When the action of pressing the brake pedal is performed, a braking operation actually occurs in response to such action on a brake system of the vehicle (braking time). In the braking time, main braking (main braking time) is reached after a transient time immediately after the operation.

In order for the driver to visually confirm an object (which may be a pedestrian) on the road, to apply braking to the vehicle, and to ensure the safety of the pedestrian sufficiently, it is necessary to quickly perform early object finding and accurate grasping of the object by the visual conformation.

The inventive idea of the present invention is to promote the early object finding and the accurate grasping of the object as described above using the vehicle headlight device 1 described with reference to FIG. 2, and to attempt to ensure the safety of the pedestrian.

FIG. 4 is a schematic diagram showing a configuration of the first light irradiator 4 in the vehicle headlight device 1 according to the embodiment of the present invention. The first light irradiator 4 includes, for example, a planar-emission-type light source 11 in which a semiconductor light emitting element and an optical element are combined, a light shielding mask 12 disposed on a light emitting surface of the planar-emission-type light source 11, and a lens 13 having a focal distance f1 corresponding to the first magnification m1 that is a magnification of the radiated light.

The light shielding mask 12 includes a shielding pattern corresponding to the first radiation pattern P1. In FIG. 4, a direction indicated by an arrow is the front of the vehicle 2. In this case, the first magnification m1, which is a magnification of the light from the planar-emission-type light source 11 by the lens 13, is smaller than the magnification m2 of the normally standardized light from the light source in the low beam irradiator 5 or the high beam irradiator 6 which is the second light irradiator. Accordingly, the light radiated from the first light irradiator 4 has a beam narrower than that of the light radiated from the low beam irradiator 5 or the high beam irradiator 6, and illuminates a distant object with high illuminance.

The configuration of the first light irradiator 4 in the vehicle headlight device 1 according to the embodiment of the present invention is not limited to the configuration shown in FIG. 4. For example, the first light irradiator 4 may be configured in which a digital mirror device (DMD) including a micromirror group that has the first radiation pattern P1 and obtains the first magnification m1 is applied. By the light radiated in the form of the first radiation pattern P1 from the light irradiator 4 of the vehicle headlight device 1 including such a DMD, the pedestrian 10, who has entered the long-distance field of view 9, appears to flicker from the driver according to the first radiation pattern, and the presence of the distant pedestrian 10 is instantaneously recognized.

FIG. 5 is a diagram schematically showing the light shielding mask 12 applied to the first light irradiator 4 shown in FIG. 4. The light shielding mask 12 includes striped slits 14 for emitting the light of the planar-emission-type light source 11 in a shape corresponding to the first radiation pattern P1 (FIG. 2).

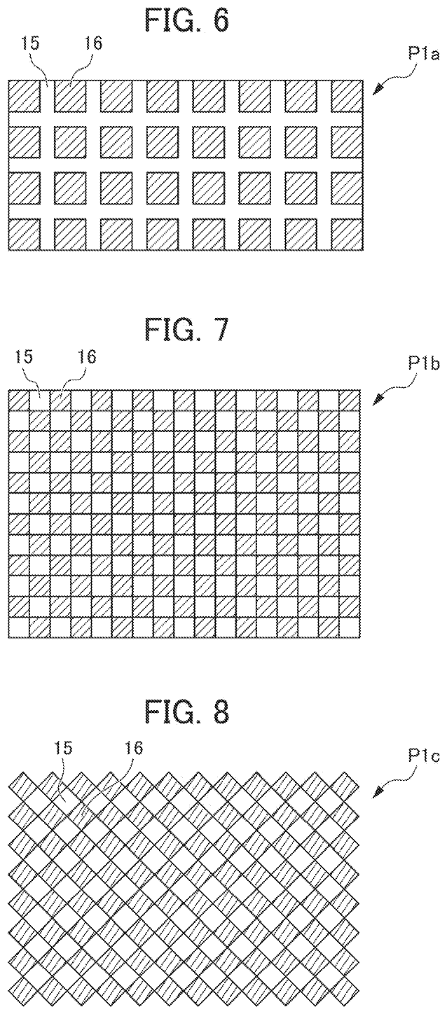

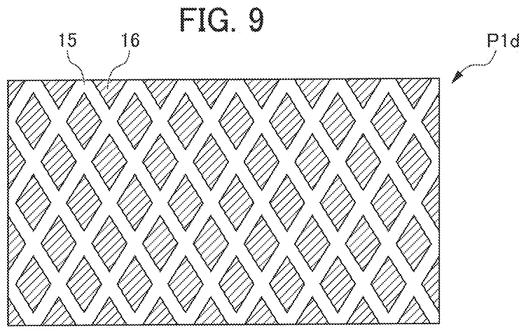

FIGS. 6 to 9 are diagrams schematically showing various examples of the first radiation pattern in the vehicle headlight device 1. FIG. 6 shows a grid-like pattern P1a in which stripes are crossed vertically and horizontally to form a grid-like bright region 15 in a dark region 16. FIG. 7 shows a checkered pattern P1b in which a rectangular bright region 15 and a rectangular dark region 16 are arranged in a checkered pattern. FIG. 8 shows a rhombic checkered pattern P1c in which a rhombic bright region 15 and a rhombic dark region 16 are arranged in a checkered pattern. FIG. 9 shows a diagonal rhombic grid pattern P1d including a bright region 15 of a mesh pattern of a diagonal rhombic grid and a dark region 16 surrounded by the bright region 15. Even by the first radiation pattern of any of the aspects shown in FIG. 6 to FIG. 9, as in the first radiation pattern P1 (FIG. 2), the pedestrian 10, who has entered the long-distance field of view 9, appears to flicker from the driver according to the first radiation pattern, and the presence of the distant pedestrian 10 is instantaneously recognized.

According to the vehicle headlight device 1 of the embodiment of the present invention, the following effects are obtained.

According to the vehicle headlight device 1 of (1), the driver easily recognizes the presence of the distant (the long-distance field of view 9 as seen from the driver of the vehicle 2) pedestrian 10 by appearing to flicker according to the first radiation pattern, using the light that reaches a long distant at a low magnification from the first light irradiator 4 in a form of the first radiation pattern P1 in which the bright region 15 and the dark region 16 are alternately repeated. Further, using light spreading over a wide region at a high magnification from the low beam irradiator 5 and/or the high beam irradiator 6, which are the second light irradiators, in a form of the second radiation pattern P2 in which the entire region is a bright region, the short-distance field of view 8 as seen from the driver is illuminated with high illuminance. Thus, it is possible to prevent or reduce the failure to notice the pedestrian 10 by the driver even under adverse conditions such as nighttime and rainy weather.

According to the vehicle headlight device 1 of (2), when the pedestrian 10 is irradiated with the light of the first radiation pattern P1, which is a stripe pattern in which the bright region 15 and the dark region 16 are arranged in parallel, the driver can easily recognize the presence of the pedestrian 10 by appearing to flicker according to the first radiation pattern.

According to the vehicle headlight device 1 of (3), when the pedestrian 10 is irradiated with the light of the first radiation pattern P1a, which is the grid-like pattern in which the grid-like bright region 15 is formed in the dark region 16, the driver can easily recognize the presence of the pedestrian 10 by appearing to flicker according to the first radiation pattern.

According to the vehicle headlight device 1 of (4), when the pedestrian 10 is irradiated with the light of the first radiation pattern P1b, which is the checkered pattern in which the rectangular bright region 15 and the rectangular dark region 16 are arranged in a checkered pattern, the driver can easily recognize the presence of the pedestrian 10 by appearing to flicker according to the first radiation pattern.

According to the vehicle headlight device 1 of (5), when the pedestrian 10 is irradiated with the light of the first radiation pattern P1c, which is the rhombic checkered pattern in which the rhombic bright region 15 and the rhombic dark region 16 are arranged in a checkered pattern, the driver can easily recognize the presence of the pedestrian 10 by appearing to flicker according to the first radiation pattern.

According to the vehicle headlight device 1 of (6), flickering appears by the light radiated in the form of the first radiation pattern P1 from the DMD including the micromirror group corresponding to the first radiation pattern P1 in the first light irradiator 4, the pedestrian 10, who has entered the long-distance field of view 9, appears to flicker as seen from the driver of the vehicle 2. Thus, the presence of the distant pedestrian 10 is instantaneously recognized from the driver. It is possible to prevent or reduce the failure to notice the pedestrian by the driver even under adverse conditions such as nighttime and rainy weather.

According to the vehicle headlight device 1 of (7), flickering appears by the light radiated in the form of the first radiation pattern P1 from the first light irradiator 4 including the predetermined planar-emission-type light source 11 and the light shielding mask 12 having the pattern corresponding to the first radiation pattern P1, and thus the pedestrian 10, who has entered the long-distance field of view 9, appears to flicker as seen from the driver of the vehicle 2. Thus, the presence of the distant pedestrian 10 is instantaneously recognized from the driver. It is possible to prevent or reduce the failure to notice the pedestrian by the driver even under adverse conditions such as nighttime and rainy weather.

According to the vehicle headlight device 1 of (8), the presence of the distant pedestrian is instantaneously recognized by the light radiated from the first light irradiator 4, and the relatively short-distance field of view 8 is illuminated with high illuminance and the pedestrian 10 is clearly recognized by the light radiated from the low beam irradiator 5 and/or the high beam irradiator 6 which are the second light irradiators of the own vehicle 2.

Although the embodiment of the present invention has been described, the present invention is not limited to the embodiment. Within the scope of the present invention, the detailed configuration may be changed as appropriate. For example, a camera may be provided in which an irradiation region of the radiated light of the vehicle headlight device 1 is a field of view to be captured, and the pedestrians and other objects may be detected by the information processing system based on the output of the camera.

### EXPLANATION OF REFERENCE NUMERALS

P1, P1a, P1b, P1c first radiation pattern
P2 second radiation pattern
1 vehicle headlight device
2 vehicle
3 turn signal light
4 first light irradiator
5 low beam irradiator (second light irradiator)
6 high beam irradiator (second light irradiator)
7 forward field of view
8 short-distance field of view
9 long-distance field of view
10 pedestrian
11 planar-emission-type light source
12 light shielding mask
13 lens
14 slit
15 bright region
16 dark region

What is claimed is:

1. A vehicle headlight device comprising:
a first light irradiator that irradiates light from a light source at a first magnification in a form of a first radiation pattern in which a bright region and a dark region are alternately repeated; and
a second light irradiator that irradiates light from a light source at a second magnification in a form of a second radiation pattern in which an entire region is a bright region, wherein
directivity of the light radiated from the first light irradiator overlaps with directivity of the light radiated from the second light irradiator, and the first magnification is smaller than the second magnification.

2. The vehicle headlight device according to claim 1, wherein the first radiation pattern is a stripe pattern in which the bright region and the dark region are arranged in parallel.

3. The vehicle headlight device according to claim 1, wherein the first radiation pattern is a grid-like pattern in which the bright region having a grid shape is formed in the dark region.

4. The vehicle headlight device according to claim 1, wherein the first radiation pattern is a checkered pattern in which the bright region having a rectangular shape and the dark region having a rectangular shape are arranged in a checkered pattern.

5. The vehicle headlight device according to claim 1, wherein the first radiation pattern is a rhombic checkered pattern in which the bright region having a rhombic shape and the dark region having a rhombic shape are arranged in a checkered pattern.

6. The vehicle headlight device according to claim 1, wherein the first light irradiation unit includes a DMD having a micromirror group corresponding to the first radiation pattern.

7. The vehicle headlight device according to claim 1, wherein the first light irradiation unit includes a predetermined planar-emission-type light source and a light shielding mask having a pattern corresponding to the first radiation pattern.

8. The vehicle headlight device according to claim 1, wherein the second light irradiation unit is a low beam irradiator and/or a high beam irradiator of an own vehicle.
